(19) United States
(12) Patent Application Publication
(10) Pub. No.: US 2012/0160819 A1
(43) Pub. Date: Jun. 28, 2012

(54) WIRE FEED SPEED MEASUREMENT DEVICE

(75) Inventor: Edward Enyedy, Eastlake, OH (US)

(73) Assignee: LINCOLN GLOBAL, INC., City of Industry, CA (US)

(21) Appl. No.: 12/978,335

(22) Filed: Dec. 23, 2010

(51) Int. Cl. B23K 9/10; G01P 3/00; B65H 54/00

(52) U.S. Cl. 219/137.71; 242/360; 73/488

(57) ABSTRACT

A system and method of monitoring a wire feed speed using a wire feed speed monitoring system and a computer peripheral pointing device having a motion sensor which senses motion of a wire passing by the motion sensor.

### BACKGROUND OF THE INVENTION

1. Field of the Invention

Devices, systems, and methods consistent with the invention relate to measuring wire feed speed.

2. Description of the Related Art

When welding it is often desirable to measure and monitor the wire feed speed of the welding wire (or electrode) as it is being fed to the welding operation. Wire feed speed measurements can be utilized during a welding operation to determine proper operation of a wire feeder or other aspect of the welding operation. Further, with wire feed speed measurements taken during a welding operation, adjustments can be made to the welding operation based on the measured information regarding the wire feed speed. Variations in wire feed speed can often be caused by a worn liner, slipping wire drive rolls or a worn contact tip, as well as other problems.

### BRIEF SUMMARY OF THE INVENTION

An exemplary embodiment of the present invention is a wire feed speed monitoring apparatus, comprising a computer peripheral pointing device having a motion sensor and a wire feed speed monitoring system to receive motion signals from the computer peripheral pointing device. The computer peripheral pointing device uses the motion sensor to monitor a feed speed and a motion of a wire and provides data related to the feed speed and motion to the wire feed speed monitoring system.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a diagrammatical representation of a welding system incorporating an exemplary embodiment of a wire feed speed measurement system of the present invention;

FIG. 2 illustrates a diagrammatical representation of a further welding system containing another exemplary embodiment of a wire feed speed measurement system of the present invention;

FIGS. 3A-3C illustrate diagrammatical representations of exemplary embodiments of the present invention;

FIG. 4 illustrates a diagrammatical representation of a further exemplary embodiment of the present invention; and

FIG. 5 illustrates a diagrammatical representation of an additional exemplary embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

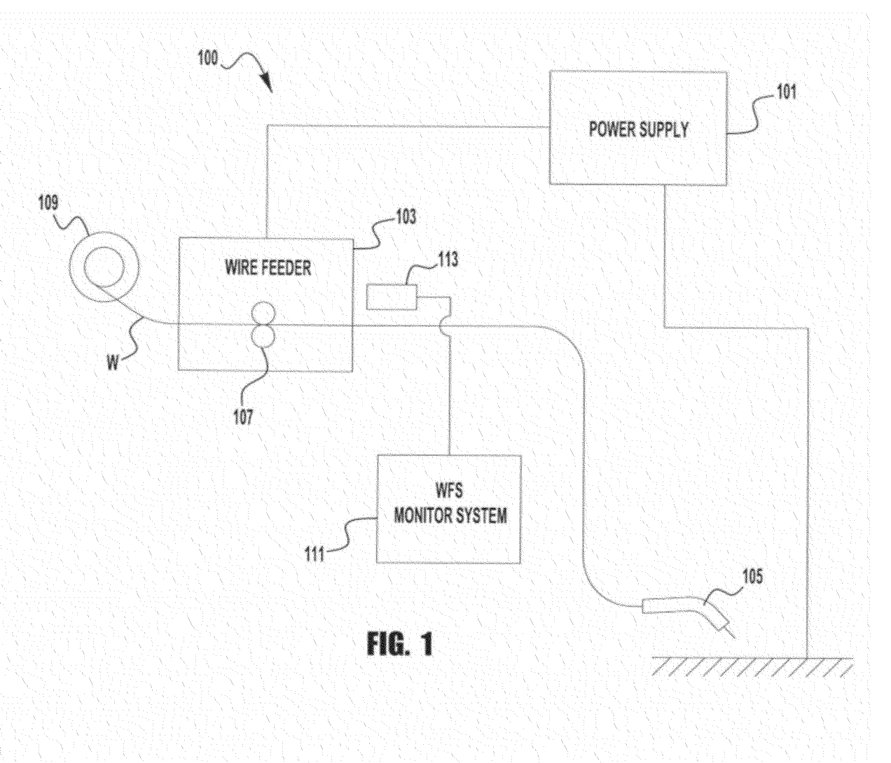

FIG. 1 is a representative diagrammatical representation of a welding system 100 incorporating an exemplary embodiment of the wire feed speed measurement system of the present invention. Specifically the welding system 100 contains a welding power supply 101 of a known type which is used to provide a welding waveform to a welding torch 105. The power supply 101 is also coupled to a wire feeder 103 which feeds a welding wire W from a wire source 109 through drive rolls 107 to the welding torch 105. Such a system is generally known in the welding industry and will not be discussed in detail herein.

Also included in the system 100 is a wire feed speed measurement device 113 which is coupled to a wire feed speed monitoring system 111. In exemplary embodiments of the present invention the wire feed speed measurement device 113 is a computer peripheral pointing system, which in some embodiments can be an “off-the-shelf” computer “mouse”. The device 113 can be of either a contact type or a non-contact type peripheral device. The contact type device often uses a roller ball at the bottom of the device 113, while the non-contact type often uses an LED light with optical sensors. As is known, computer pointing system devices (e.g., computer mouse) contain a motion sensor which is capable of tracking movement in both an X and Y direction and communicates this movement to processors so that the movement data can be used as desired. Because the structure, function and operation of computer peripheral pointing systems (computer mouse) is well known by those in the computer industry and need not be discussed or described in detail herein.

The use of a computer peripheral pointing system as the wire feed speed measurement device 113 is advantageous over known wire feed speed measurement systems. Specifically, some wire feed speed measurement systems are extremely expensive or require significant contact with the welding wire W such that the devices squeeze the wire W and can deform it. Further, current wire feed speed measurement devices can only measure the linear movement of the wire. However, it is often important to also determine if the wire W is rotating, which can be detrimental to a proper welding operation. The use of a computer peripheral pointing system as the sensor eliminates each of these drawbacks as they are low cost items and either requires no contact with the wire or minimal contact to track the movement of the wire.

In operation the device 113 is positioned such that its motion sensor, whether it be a contact or non-contact type can accurately sense the movement of the wire. In further embodiments, the device 113 is modified to include a wire guide to guide the wire W under the sensor for accurate detection of wire feed speed. During operation the linear movement of the wire is sensed by the device 113 and the movement data is transmitted, wirelessly or via a physical connection, to the wire feed speed monitor system 111. The wire feed speed monitor system 111 can be any type of computer system capable of receiving data from the device 113 and is specially programmed to interpret the movement signals from the device 113 in to wire feed speed measurements of the wire W during operation. In some exemplary embodiments of the present invention an optical computer peripheral pointing device 113 is employed which has a sampling rate of 1,500 samples per second. Such a sampling rate allows the wire feed speed measurement system to detect variations in the wire feed speed wire traveling up to 1,200 inches per minute. This is significantly improved over existing wire feed speed detection systems.

Further, in addition to interpreting the linear movement of the wire W, the wire feed speed monitor system 111 can also have programming to monitor rotation of the wire W as it is fed to the torch 105. This would be interpreted by sensed movement in the Y direction by the device 113. This information can be utilized by the system to track rotation in the wire W which could be an indication of a problem in the wire feeding system or the wire.

The wire feed speed monitoring system 111 can be any type of computer system which is programmable such that it can be programmed to interpret the data and information from the device 113 into wire feed speed. The system 111 can also include memory devices to store wire feeding data and information and may also include a display device to visually display information related to the wire feeding operation, including: wire feed speed, fluctuations or variations in wire feed speed, wire rotation or other desired variables.

The device 113 can be positioned at any positioning along the wire feeding system. However, in an exemplary embodiment of the present invention the device 113 is positioned downstream of the wire feeder rollers 107. In a further exemplary embodiment of the present invention, multiple devices 113 are employed. In this embodiment the wire feed speed at multiple locations in the wire feeding system can be monitored for variations. For example, a first device 113 can be positioned upstream of the wire feeder 103, prior to the wire W impacted the rollers 107, and a second wire feed device can be positioned downstream of the rollers 107. In this configuration, the wire feed speed monitoring system 111 can determine if any speed differential exists between the detected wire feed speeds between the first and second devices 113. This information can be utilized to determine the operation of the wire feeder 103 and/or the rollers 107. For example, if a differential, over a threshold differential, is detected in the wire feed speeds from the first and second devices the wire feed speed monitoring system 111 can issue a warning and/or stop the wire feeder 103 or the power supply 101.

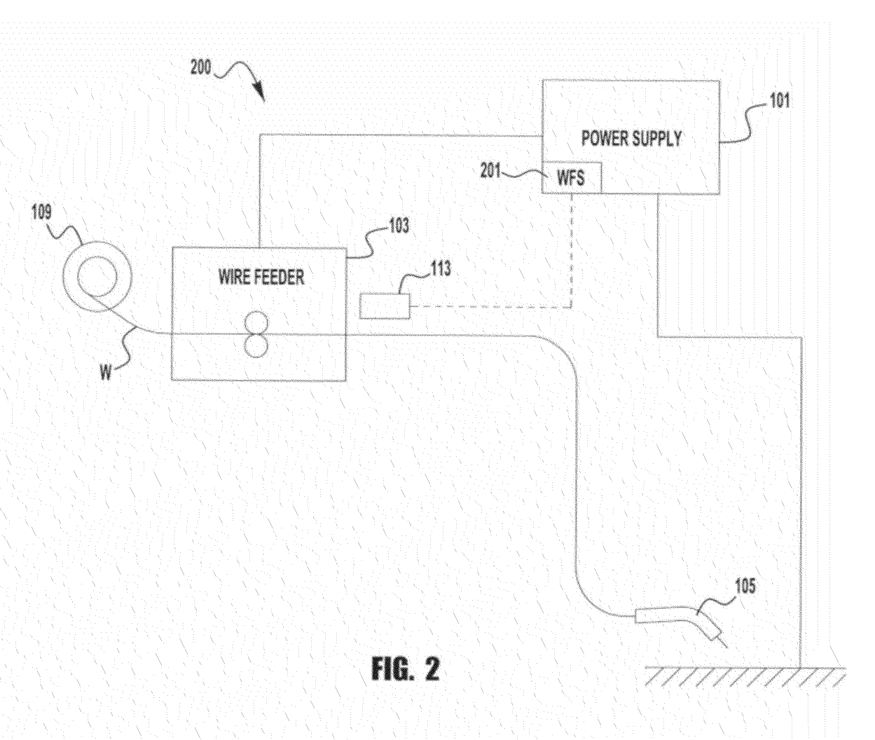

FIG. 2 depicts another exemplary welding system 200. However, in this welding system the wire feed speed monitoring system 201 is incorporated into the control electronics of the power supply 101. Further, the device 113 communicates with the wire feed speed monitoring system 201 wirelessly. In an alternative embodiment, the device 113 can be hardwired to the system 201 and/or the power supply 101. In this embodiment the wire feed speed monitoring system 201 can display the detected wire feed speed on the power supply 101 and/or can assist in the control of the wire feed speed. For example, in some exemplary embodiments if the detected wire feed speed falls below or exceeds a threshold the wire feed speed control system 201 can issue an emergency stop signal to the power supply 101 and or the wire feeder 103 to stop the welding and feeding operation. Alternatively or additionally, the wire feed speed monitor system 201 can be used to control the wire feeder 103 based on the measured wire feed speed from the device 113. For example, if the detected wire feed speed of the wire W is outside of an acceptable operating range the wire feed speed monitoring system 201 instructs the power supply 101 and/or the wire feeder 103 to either increase or decrease the wire feed speed so that the wire feed speed is maintained within the desired operational range to continue a proper welding operation.

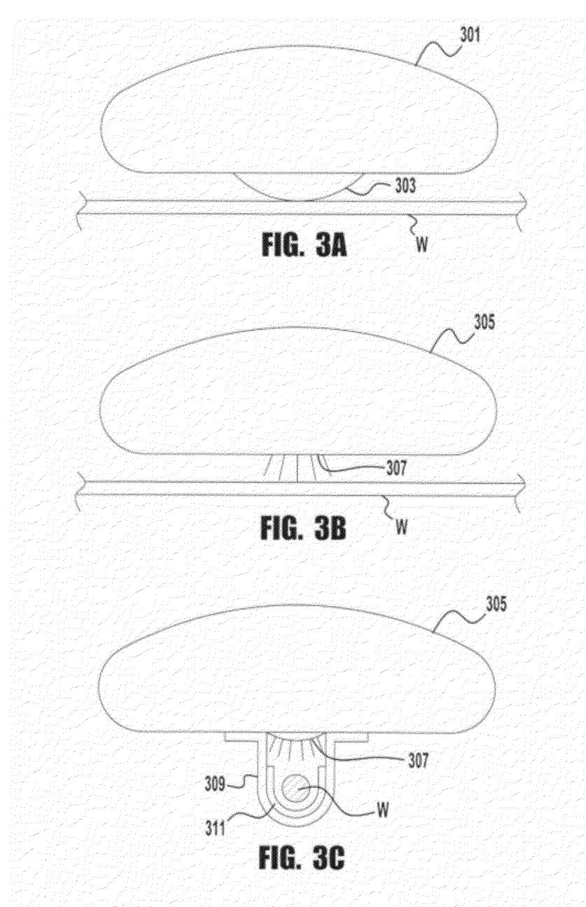

FIGS. 3A to 3C depict various embodiments of the wire feed speed measuring device 301/305 of the present invention. As depicted the device 301/305 is a computer peripheral pointing device, a computer mouse. In FIG. 3A the device 301 is a contact type device using a ball 303, while in FIGS. 3B and 3C the device 305 is a non-contact device which, for example, uses an LED and optical sensors to detect movement. As shown in FIG. 3C the device 305 can be quipped with a wire guide 309, which can be affixed by any known means, to ensure that the wire W is positioned under the motion sensor 307 of the device 305. The guide 309 may also include a friction reducer 311 which reduces friction between the wire W and the guide 309 and to reduce or eliminate scratches in the wire W.

The device 301/305 shown in FIGS. 3A-3C is shown as typical off-the-shelf computer peripheral pointing devices. However, in other exemplary embodiments of the present invention, it is not necessary that the outer shell or housing the pointing devices be maintained for operation of the device 301/305 in embodiments of the present invention.

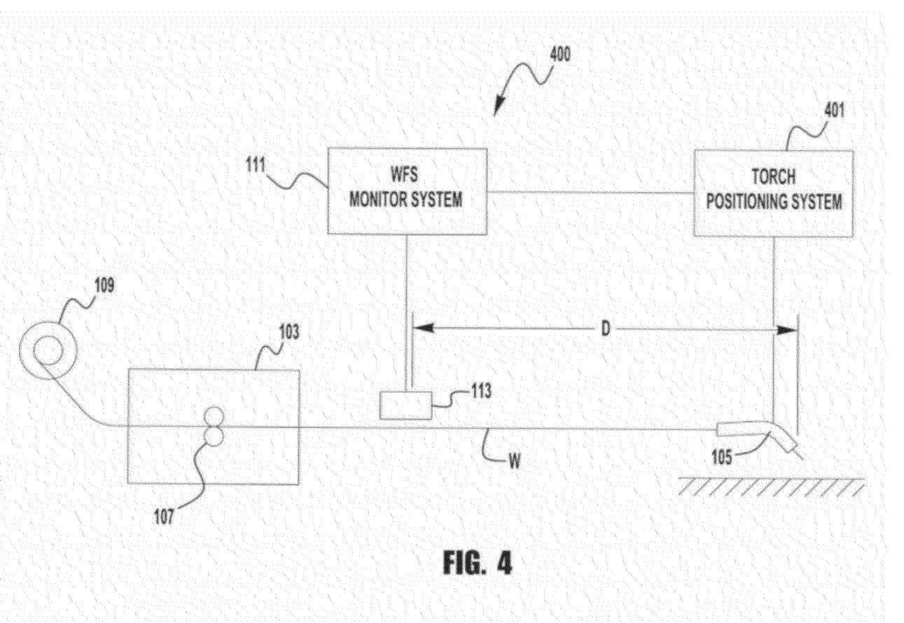

Turning now to FIG. 4, another exemplary embodiment 400 of the present invention is depicted which is capable of monitoring and detecting cast or twisting in the welding wire W. Specifically, it is known that welding wires W can often have a cast, twist or curvature in the wire which may be a function of its winding and/or packaging process. This anomaly in the wire can affect the positioning of the wire W during the welding process. For example, if a straight line weld is desired a twist or cast in the wire W can result in a non-straight weld bead because the wire W will move as it exits the torch 105. That is, a significant cast or twist in the wire W can cause the weld bead to move to either side of a desired straight path. In welding operations which require high precision this can be problematic. The system 400 shown in FIG. 4 is capable of minimizing the effects if certain twists and cast in the wire W during welding.

Specifically, in this embodiment the wire feed speed monitoring system 111 communicates with a torch positioning system 401. The torch positioning system 401 is employed and configured to change the positioning of the welding torch 105 during the welding process. The torch positioning system 401 can use motors, gears or other mechanisms (not shown) to change the positioning of the torch 105. Such mechanisms are known in the automatic and robotic welding industry and will not be described in detail herein.

During welding the device 113 is positioned a distance D from the exit of the torch tip in the welding torch 105 such that the distance D is known. The distance D can be predetermined and programmed into the wire feed speed monitoring system 111. As described above, the device 113 and monitoring system 111 can detect the wire feed speed and any rotation in the wire W as it is being fed. During welding, if a twist is detected in the wire W by the device 113 and monitoring system 111 the monitoring determines whether or not the torch 105 needs to be moved to accommodate for the detected twist. That is, in an exemplary embodiment if a twist in the wire is detected the monitoring system 111 then communicates with the torch positioning system 401 to adjust the positioning of the torch 105 to ensure that the weld bead is maintained in its desired path even though a twist or anomaly exists in the wire W. The monitoring system 111 bases the communications with the torch positioning system 401 on the distance D and the detected wire feed speed and detected twist in the wire W. Specifically, the monitoring system 111 determines the length of time the detected twist will take to travel the distance D at the detected wire feed speed and instructs the torch positioning system 401 to move the torch 105 the appropriate distance at the appropriate time. That is, at the time the detected twist will reach the exit of the welding torch 105.

In another exemplary embodiment of the present invention, the monitoring system 111 only communicates with the torch positioning system 401 when the twist or anomaly in the wire is over a threshold amount. Thus, the torch 105 will not be moved if the detected twist in the wire W is not determined to be significant or would render the weld bead unacceptable. However, if the twist or anomaly is determined to be over the threshold amount then the monitor system 111 communicates with the positioning system 1401 to adjust the positioning of the torch 105 appropriately.

It is noted that although the monitoring system 111 and positioning system 401 are shown in FIG. 4 as separate components, in other exemplary embodiments these components can be integral into a single controller system. The present invention is not limited in this regard.

In a further exemplary embodiment, the system 400 shown in FIG. 4 controls the travel speed of the torch 105 based on the detected wire feed speed of the wire W. Specifically, it may be desirable to maintain a constant amount of welding wire W over a specified length of the weld to be created. If the wire feed speed of the wire W changes during welding this may result in either too much or too little of the wire W being delivered to the weld for a specified length of weld. Therefore, similar to the discussion above the monitoring system 111 and the positioning system 401 are used to control the travel speed of the torch 105 based on the detected wire feed speed. So, if the detected wire feed speed increases then the positioning system 401 will increase the travel speed of the torch 105 to maintain a constant deposition rate. Similarly, if the wire feed speed decreases the positioning system will slow the travel speed of the torch 105 so as to maintain the desired deposition rate. Of course, in some exemplary embodiments of the present invention, changes in the travel speed of the torch 105 will only incur if the detected wire feed speed is higher than or lower than a threshold. Therefore, so long as the wire feed speed is within an acceptable operational range there will be no changes in the travel speed of the torch 105.

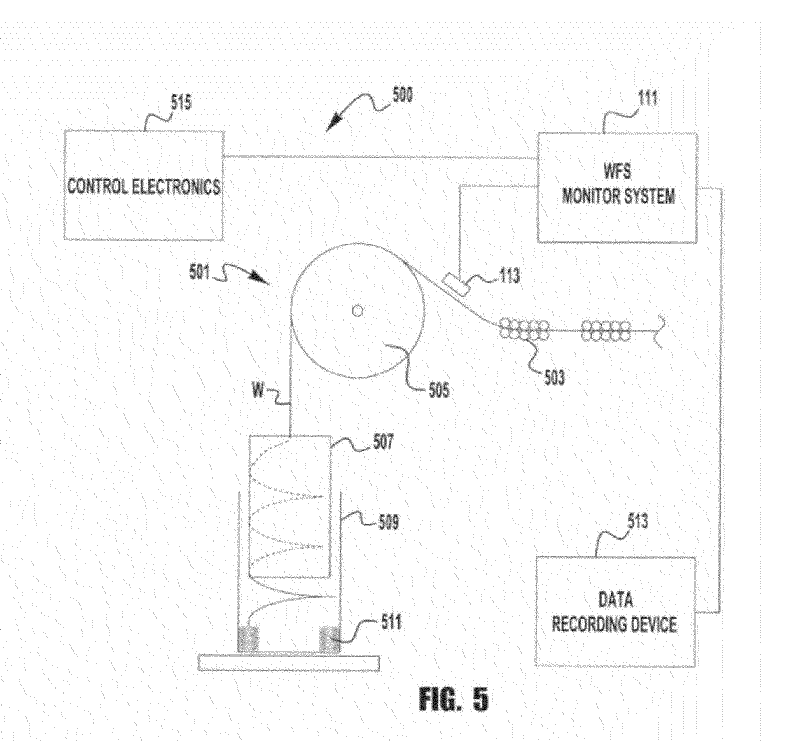

Another aspect of the present invention is depicted in FIG. 5. In this embodiment, aspects of the invention are employed during the wiring drawing/packaging process. In the exemplary embodiment shown in FIG. 5 a wire winding system 500 is shown which is used to wind welding wire W into a welding wire container 507, which is often a bulk welding wire container. The system 500 contains a wire winding machine 501 which has a series of shaping rollers 503, which are used to shape the wire W, a capstan 505 and a laying head 507. During winding, the wire W is pulled by the capstan 505 and pushed down through the laying head 509 into the container to create a spool or coil or weld wire 511. The general construction and operation of wire winding machines is known and will not be discussed in detail herein. However, it is noted that the present invention is not limited to the specific winding machine 501 described herein and can be used on any wire winding or wire drawing machines, which draw the wire W from a larger diameter to a smaller diameter.

During winding, the wire W is deposited into a spool of wire 511 by the laying head 507 which lays the wire W in a series of loops. Because of this process a torsional force is placed on the wire, causing the wire to twist. It is known that during winding it is not desirable for this twist to migrate upstream beyond the capstan. However, with current systems when this migration occurs it is often undetected until a significant anomaly is detected in the wire W after it is wound in the package 509.

Therefore, in an exemplary embodiment of the present invention, the device 113 is placed between the shaping rollers 503 and the capstan 505 to detect the wire feed speed between these components as well as any twisting of the wire W. The information related to wire twist and wire feed speed is transmitted from the monitoring system 111 to a date recording device 513, which can then be used to evaluate the spool of wire 511 in the container 509. For example, the data can be used to determine if the spool of wire 511 meets desired parameters for customers and the data can be used to determine the pricing and quality of the wire in the container 507. Furthermore, the monitoring system 111 can communicate with the control electronics 515 for the winding machine 501 and if the detected twist or wire feed speed is beyond an acceptable range then the control electronics 515 can stop the wire winding machine 501. This will prevent the entire filling of a container 509 with defective wire.

In the embodiment shown in FIG. 5 only a single device 113 is shown between the capstan 506 and the shaping rollers 503. However, the present invention is not limited to this positioning of the device 113. Further, embodiments of the present invention can employ more than one device 113 at different positions in the wire winding, drawing or manufacturing process as desired to monitor the wire feed speed and/or twisting of the wire at multiple locations.

Furthermore, embodiments of the present invention are not limited to use with winding machines 501 for depositing wire W into a container, but can be used in all types of winding machines, including those that wind wire W onto spools and/or reels.

Embodiments of the present invention can be used for all types of welding in which a welding wire is continuously fed to a welding torch, including but not limited to MIG, flux-cored, and submerged welding. Further, other exemplary embodiments of the present invention can be utilized in dual wire feeder system or in systems where more than one wire feeder is being utilized. In such embodiments the wire feed speed monitoring system can be used to monitor the wire feed speed of the multiple wire feeding operations.

Further, although the exemplary embodiments have been discussed above in the context of a welding system, the present invention is not limited in this regard as embodiments of the present invention can be utilized in any system in which the feed speed of a wire is desired to be monitored.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A wire feed speed monitoring apparatus, comprising:
a wire motion detection device having a motion sensor; and
a wire feed speed monitoring system to receive motion signals from said wire motion detection device,
wherein said wire motion detection device uses said motion sensor to monitor a feed speed and a motion of a wire and provides data related to said feed speed and said motion to said wire feed speed monitoring system.

2. The wire feed speed monitoring apparatus of claim 1, wherein said motion is a rotation of said wire.

3. The wire feed speed monitoring apparatus of claim 1, wherein said motion sensor is a non-contact type motion sensor.

4. The wire feed speed monitoring apparatus of claim 1, wherein said wire motion detection device comprises a wire guide structure to guide said wire adjacent to said motion sensor.

5. The wire feed speed monitoring apparatus of claim 1, wherein said motion sensor has a sampling rate of at least 1,500 samples per second.

6. The wire feed speed monitoring apparatus of claim 1, wherein said wire feed speed monitoring system provides a signal to at least one of a welding power supply and a wire feeder feeding said wire based on at least one of said detected wire feed speed and said motion.

7. The wire feed speed monitoring apparatus of claim 1, wherein said wire feed speed monitoring system controls a movement of a welding torch based on at least one of said detected wire feed speed and motion of said wire.

8. The wire feed speed monitoring apparatus of claim 7, wherein said wire motion detection device is positioned a distance D from said welding torch and said wire feed speed monitoring system controls said movement of said torch based on said distance D and said detected wire feed speed.

9. The wire feed speed monitoring apparatus of claim 1, wherein said motion detection device is a computer peripheral pointing device.

10. A method of monitoring a wire feed speed, comprising:
passing a wire past a motion sensor of a wire motion detection device;
sensing a speed and a motion of said wire by said motion sensor; and
providing data related to said speed and said motion from said motion sensor to a wire feed speed monitoring system.

11. The method of monitoring a wire feed speed of claim 10, wherein said motion is a rotation of said wire.

12. The method of monitoring a wire feed speed of claim 10, wherein said motion sensor is a non-contact type motion sensor.

13. The method of monitoring a wire feed speed of claim 10, wherein said wire motion detection device comprises a wire guide structure to guide said wire adjacent to said motion sensor.

14. The method of monitoring a wire feed speed of claim 10, wherein said motion sensor samples at least said speed of said wire at 1,500 samples per second.

15. The method of monitoring a wire feed speed of claim 10, further comprising providing a signal to at least one of a welding power supply and a wire feeder feeding said wire based on at least one of said detected wire feed speed and said motion.

16. The method of monitoring a wire feed speed of claim 10, further comprising controlling a movement of a welding torch based on at least one of said detected wire feed speed and motion of said wire.

17. The method of monitoring a wire feed speed of claim 16, wherein said wire motion detection device is positioned a distance D from said welding torch and said controlling of said movement of said torch is based on said distance D and said detected wire feed speed.

18. The method of monitoring a wire feed speed of claim 10, wherein said motion detection device is a computer peripheral pointing device.

19. A wire winding system, comprising:
a wire winding device which winds a wire;
a wire motion detection device having a motion sensor; and
a wire feed speed monitoring system to receive motion signals from said wire motion detection device,
wherein said wire motion detection device uses said motion sensor to monitor a feed speed and a motion of said wire and provides data related to said feed speed and said motion to said wire feed speed monitoring system.

20. The wire winding system of claim 19, wherein said wire motion detection device monitors said wire feed speed and said motion of said wire adjacent to a capstan of said wire winding device.
